(19) United States
(12) Patent Application Publication
(10) Pub. No.: US 2010/0102049 A1
(43) Pub. Date: Apr. 29, 2010

(54) ELECTRODES HAVING LITHIUM ALUMINUM ALLOY AND METHODS

(76) Inventor: James M. Keegan, Chardon, OH (US)

Correspondence Address: ULMER & BERNE, LLP;ATTN: DIANE BELL, 600 VINE STREET, SUITE 2800, CINCINNATI, OH, 45202-2409, US

(21) Appl. No.: 12/257,763

(22) Filed: Oct. 24, 2008

(51) Int. Cl. B23K 35/34

(52) U.S. Cl. 219/146.22

(57) ABSTRACT

A welding electrode and a method of manufacturing the same are provided. The welding electrode can include a flux portion having a material which can contain a lithium aluminum alloy.

### TECHNICAL FIELD

Electrodes and methods are provided for improved weld performance. More particularly, electrodes and methods involving a lithium aluminum alloy are provided.

### BACKGROUND

Conventional electrodes and methods of manufacturing such electrodes have been available for years. However, while such conventional electrodes and methods somewhat exclude nitrogen from entering a weld during a welding process, they do not sufficiently exclude nitrogen from a welding arc plasma to prevent thermite reactions. The elimination of thermite reactions will improve weld metal ductility.

### SUMMARY

In accordance with one embodiment, a welding electrode comprises a metallic electrode portion and a flux portion adjacent and attached to the metallic electrode portion. The flux portion comprises a material comprising a lithium aluminum alloy.

In accordance with another embodiment, a method of manufacturing a welding electrode comprises attaching a flux portion to a metallic electrode portion to form a welding electrode. The flux portion comprises a material comprising a lithium aluminum alloy.

### BRIEF DESCRIPTION OF THE DRAWINGS

While the specification concludes with claims particularly pointing out and distinctly claiming the invention, it is believed that the same will be better understood from the following description taken in conjunction with the accompanying in which:

FIG. 1 is a representation of an iron-carbon phase diagram;

FIG. 2 is a cross-sectional view depicting a welding electrode in accordance with one embodiment; and

FIG. 3 is a cross-sectional view depicting a welding electrode in accordance with another embodiment.

### DETAILED DESCRIPTION

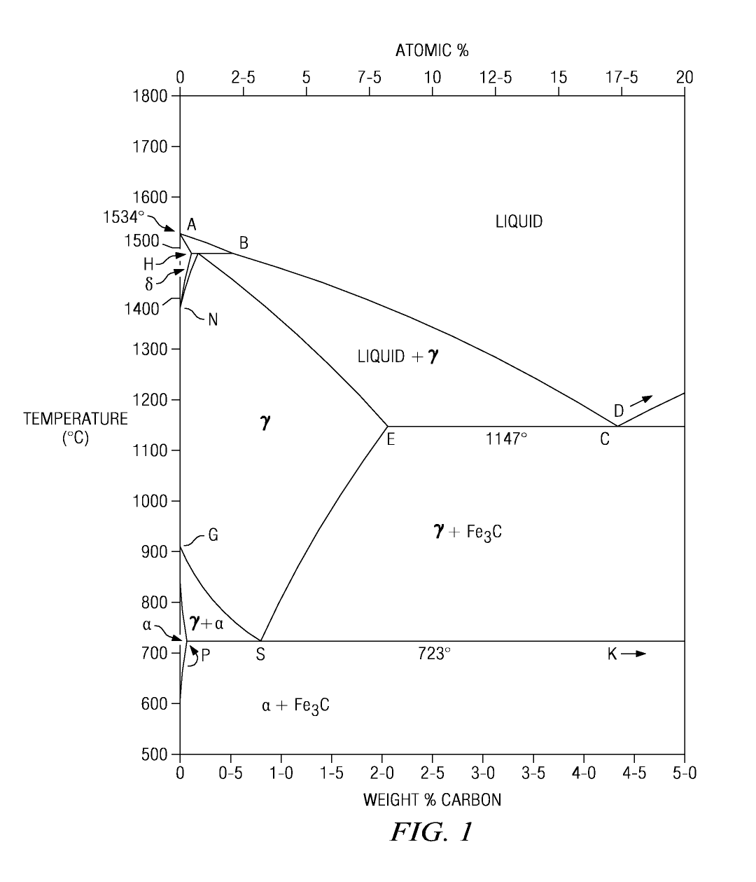

Embodiments are herein described in detail in connection with the drawings of FIGS. 1-3, wherein like numbers (e.g., 110, 210) indicate the same or corresponding elements throughout the drawings.

FIG. 1 depicts an iron-carbon phase diagram generally showing each of the equilibrium phases of the thermodynamically distinct gamma, delta and alpha phases of steel. FIG. 1 is provided as a reference to aid in further understanding of the following discussion related to the electrodes and methods of manufacture as discussed herein.

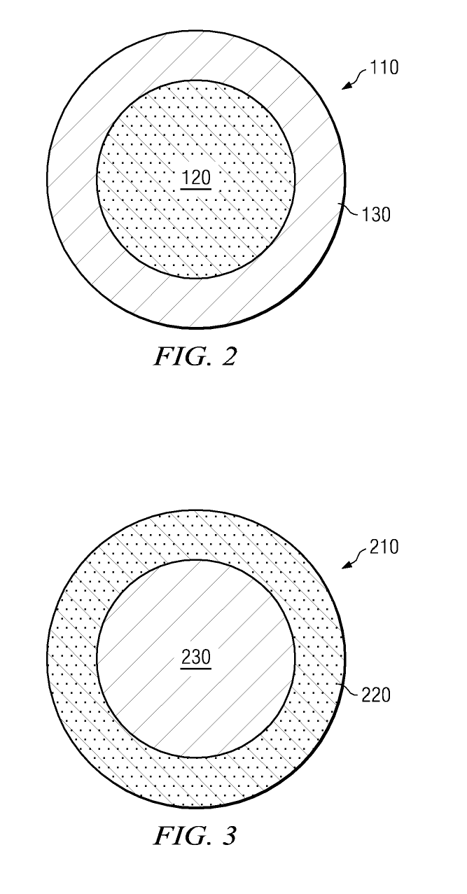

FIGS. 2 and 3 illustrate cross-sections of welding electrodes 110 and 210. Welding electrode 110, as illustrated in FIG. 2, depicts an embodiment of a flux-cored electrode in which a flux portion 120 can be substantially surrounded by a metallic electrode portion 130 and the flux portion 120 can serve as a core of the electrode 110. FIG. 3 depicts a self-shielding electrode 210 having a structure generally referred to as a “stick electrode” in which a metallic electrode portion 230 can be substantially surrounded by a flux portion 220 coating the metallic electrode portion 230. In each configuration as illustrated in FIGS. 2 and 3, the flux portions 120 and 220 are employed to provide a shielding gas during a welding operation in order to exclude nitrogen from entering a weld metal, which can be accomplished by shielding air from the weld pool during the welding operation. These types of welding electrodes are generally known as self-shielding electrodes. Self-shielding electrodes are used in many different types of welding operations, such as shielded metal arc welding (“SMAW”) and flux-cored arc welding (“FCAW”). In one embodiment, a flux portion can range from about 5% to about 50% by weight of an electrode. In another embodiment, a flux portion can range from about 10% to about 30% by weight of an electrode.

To achieve the exclusion of nitrogen from a weld metal, conventional self-shielding electrodes contain a certain quantity of aluminum in either a flux portion, a metallic electrode portion, or both portions. The presence of aluminum aids in blocking nitrogen and oxygen from the weld metal. However, the presence of aluminum in a weld metal has the tendency to close the gamma loop on the iron-carbon phase diagram (the gamma loop is generally illustrated in FIG. 1). Due to this occurrence, the presence of aluminum tends to restrict the phase transformation from the delta to the gamma to the alpha phases. A result of this restriction is the creation of large unrefined grains in the structure of a weld metal which, in turn, results in a weld which has poor ductility and is brittle. Lithium present in the lithium aluminum alloy vaporizes and displaces nitrogen and oxygen from the weld pool. In this case, the lithium present in the lithium aluminum alloy may react with nitrogen and oxygen forming lithium oxides or nitrides. Lithium may also create a metallic vapor and reduce the partial pressure of oxygen and nitrogen in the weld plasma. Brittle welds are undesirable in many applications. As such, an electrode is needed having a composition which blocks the entry of nitrogen into a weld metal and does not close or significantly interfere with the phase transfer of a weld metal during a welding operation.

In the welding processes generally discussed above, an electrode generates its own shielding gas, via a material forming a flux portion, to remove oxygen and nitrogen from the area of the molten weld pool. A shielding gas is generated by compounds contained in a flux portion which decompose and/or vaporize during welding. The released gas reduces the partial pressure of nitrogen and oxygen in the welding arc environment so that absorption of nitrogen and oxygen from the weld pool is reduced.

In one embodiment, a flux portion can include a material which includes a lithium aluminum alloy. The presence of a lithium aluminum alloy in the flux portions 120 and 220 provides for a reduction of aluminum used in the welding electrodes 110 and 210 illustrated in FIGS. 2 and 3. In applications, such as welding, lithium aluminum alloys can act as denitriders and deoxidizers to eliminate nitrogen and oxygen from a weld pool. However, lithium aluminum alloys can also act as denitriders and deoxidizers with minimal, or no, negative effects to the phase transformation of iron-carbon systems. Thus, in one embodiment, at least some of the aluminum which would normally be present in a flux portion of an electrode is replaced with a lithium aluminum alloy. In one embodiment, a lithium aluminum alloy can include from about 0.5% to about 15% lithium and from about 85% to about 99.5% aluminum. In another embodiment, a lithium aluminum alloy can comprise from about 1.0% to about 5.0% lithium and from about 87% to about 95% aluminum, wherein the remainder of the lithium aluminum alloy comprises other, compounds (e.g., copper, magnesium, manganese or zirconium). For example, in one embodiment, a lithium aluminum alloy could comprise a powder having about 2.45% lithium, about 0.12% zirconium, about 1.3% copper, about 0.95% magnesium and the remainder aluminum.

The use of lithium aluminum alloys in a flux portion of an electrode can provide for the reduction of the amount of aluminum present in a welding electrode without reducing the shielding performance of the welding electrode and without any adverse metallurgical effects in the resulting weld. In fact, using electrodes in accordance with various embodiments discussed herein can result in improved metallurgical properties over conventional electrodes because the overall amount of aluminum remaining in the weld is reduced.

As discussed above, the presence of aluminum in a weld pool can interfere with the phase transformation of steel from its delta to gamma to alpha phases. In particular, the presence of aluminum tends to close the gamma loop on the iron-carbon phase diagram. This results in the creation of a large unrefined grain structure in the weld, which can lead to a brittle weld lacking toughness and durability. Thus, conventional welding electrodes typically minimize the amount of aluminum used in order to act as a denitrider and deoxidizer during the welding process. Conventional welding electrodes generally include aluminum in an amount ranging from 8% to 15% by weight of the electrode, depending on the electrode application and type. The use of these conventional electrodes can result in weld deposits in a final weld as high as about 1.5% by weight of aluminum. However, as the amount of aluminum in weld deposits approaches an amount such as 1.5% by weight, the final weld can become brittle and lack sufficient toughness.

Electrodes having a lithium aluminum alloy component, as discussed herein, can prevent the above-referenced adverse metallurgical effects, while also maintaining the desired shielding capabilities. Again, this is because a lithium aluminum alloy, in welding applications, which act as denitriders and deoxidizers without tending to close the gamma loop of the weld metal. Thus, embodiments of electrodes described herein allow for less aluminum to be used in an electrode or having the amount of aluminum eliminated entirely, with little or no compromise in the shielding performance of the electrode and no adverse metallurgical effects. In fact, electrodes in accordance with such embodiments can result in superior metallurgical properties, such as weld toughness, over conventionally used electrodes.

In one embodiment, a lithium aluminum alloy can be present in a material which forms a flux portion of a welding electrode. Because lithium aluminum alloys can generally be in powder and/or granular form, placement of a lithium aluminum alloy in a material forming a flux portion of a welding electrode is convenient from a manufacturing perspective. Lithium aluminum alloy powder can be added to a flux portion of a welding electrode during a mixing process to form the flux portion being added to the electrode. A flux portion is then added to form a final welding electrode during a manufacturing process. As discussed herein, a flux portion can be substantially surrounded by a metallic electrode portion and serve as a core of an electrode or a flux portion can be manufactured to substantially surround a metallic electrode portion so as to form a welding electrode. It will be appreciated that a metallic electrode portion can be formed from any suitable metal compound(s) and/or alloy(s) used in any applicable welding applications. Moreover, an electrode can be manufactured to serve many welding applications, and, as such, it will be appreciated by one skilled in the art that the physical dimension of an electrode (e.g., the diameter of the electrode) and integration of a flux portion as part of an electrode are similar to that of known welding electrodes.

In one embodiment, a flux portion contains up to about 15% by weight of lithium aluminum alloy. In a further embodiment, a flux portion contain up to about 10% by weight of lithium aluminum alloy. In yet another embodiment, a flux portion contains about 1% to about 5% by weight of lithium aluminum alloy. In an additional embodiment, a flux portion contains at least about 0.5% by weight of lithium aluminum alloy. Of course, the overall percentage of lithium aluminum alloy present in a flux portion of an electrode can be a function of the electrode type, desired performance and construction. For example, it is understood that the amount of lithium aluminum alloy employed in an electrode for a FCAW may be different than the amount employed for a SMAW to achieve the same or similar weld quality and performance.

In one embodiment, a lithium aluminum alloy can completely replace aluminum in the overall electrode. Thus, if a conventional electrode contains about 10% aluminum by weight of a flux portion, one embodiment of an electrode can contain about 10% lithium aluminum alloy by weight of a flux portion with no added aluminum. Of course, it will be appreciated by those of ordinary skill in the art that, due to various manufacturing techniques, trace amounts of aluminum may exist in an electrode as a function of manufacturing processes and the materials used. Thus, the amount of intentionally added aluminum can be replaced with a lithium aluminum alloy.

In a further embodiment, it is not necessary to replace the entire amount of added aluminum with a lithium aluminum alloy, as the benefits discussed herein can also be achieved by using a combination of aluminum and lithium aluminum alloy in the overall electrode. For example, if a conventional electrode contains about 10% aluminum by weight of a flux portion, an embodiment can include having an electrode contain about 5% aluminum by weight of a flux portion and about 5% lithium aluminum alloy by weight of the flux portion. It will also be appreciated that in one embodiment, the weight percentage of aluminum used can be greater than the weight percentage of lithium aluminum alloy used in an electrode.

It is noted that, depending on the reactivity of a lithium aluminum alloy, the percentages of lithium aluminum alloy utilized in an electrode may need to be adjusted to achieve a desired performance. Thus, it will be appreciated that one skilled in the art can determine the appropriate amount of lithium aluminum alloy employed, whether the lithium aluminum alloy is combined with aluminum, or is used by itself in forming a particular electrode. As such, the overall amount of lithium aluminum alloy used may be a function of the desired performance of an electrode with regard to its ability to provide the needed deoxidization and denitridation and produce a weld having desirable metallurgical properties, such as toughness.

By employing various embodiments, the amount of aluminum in weld metal can be appreciably reduced, without a decrease in shielding performance during the welding process. Aluminum reacts with oxygen and nitrogen in the welding arc and weld pool, and thus, Al—N and Al₂O₃ will form as inclusions. Some of these inclusions float out of the weld pool and some stay in the weld metal. In fact, the reaction with aluminum to form Al—N continues in the solid state. For example, an electrode having an aluminum-to-lithium aluminum alloy ratio of about 1 can result in a weld having about a 50% reduction of aluminum in the weld. So, if the use of a conventional electrode results in a weld having about 1.5% by weight of aluminum, an embodiment of an electrode described herein could yield a weld having about 0.75% by weight of aluminum. Thus, metallurgical properties of the weld can be improved without sacrificing shielding performance of an electrode.

In a further embodiment, an electrode can contain a combination of lithium aluminum alloy with another compound having a source of lithium including, but not limited to, lithium aluminate, lithium fluoride and lithium ferrate. For example, in one embodiment, a flux portion of an electrode can contain about 9% of lithium aluminum alloy by weight and about 1% of lithium ferrate by weight.

The foregoing description of embodiments and examples has been presented for purposes of illustration and description. It is not intended to be exhaustive or to limit the invention to the forms described. Numerous modifications are possible in light of the above teachings. Some of those modifications have been discussed, and others will be understood by those skilled in the art. The embodiments were chosen and described in order to best illustrate various embodiments as are suited to the particular use contemplated. It is hereby intended that the scope of the invention be defined by the claims appended hereto.

What is claimed is:

1. A welding electrode comprising:
a metallic electrode portion; and
a flux portion adjacent and attached to the metallic electrode portion, wherein the flux portion comprises a material comprising a lithium aluminum alloy.

2. The welding electrode of claim 1, wherein the metallic electrode portion comprises an outer surface, and wherein the flux portion substantially surrounds the outer surface of the metallic electrode portion.

3. The welding electrode of claim 1, wherein the metallic electrode portion defines a core, wherein the flux portion is located within the core of the metallic electrode portion and the metallic electrode portion substantially surrounds the flux portion.

4. The welding electrode of claim 1, wherein the flux portion ranges from about 5% to about 50% by weight of the welding electrode.

5. The welding electrode of claim 4, wherein the flux portion ranges from about 10% to about 30% by weight of the welding electrode.

6. The welding electrode of claim 1, wherein the material of the flux portion comprises the lithium aluminum alloy in an amount up to about 15% by weight.

7. The welding electrode of claim 6, wherein the material of the flux portion comprises from about 1% to about 5% by weight of the lithium aluminum alloy.

8. The welding electrode of claim 1, wherein the material of the flux portion comprises the lithium aluminum alloy in an amount of at least about 0.5% by weight.

9. The welding electrode of claim 1, wherein the material of the flux portion further comprises lithium ferrate.

10. A method of manufacturing a welding electrode, the method comprising:
attaching a flux portion to a metallic electrode portion to form a welding electrode, wherein the flux portion comprises a material comprising a lithium aluminum alloy.

11. The method of claim 10, wherein the metallic electrode portion comprises an outer surface, and wherein attaching the flux portion comprises substantially surrounding the outer surface of the metallic electrode portion with the flux portion.

12. The method of claim 10, wherein the metallic electrode portion defines a core, and wherein attaching the flux portion comprises locating within the core of the metallic electrode portion the flux portion such that the metallic electrode portion substantially surrounds the flux portion.
